(19) United States
(12) Patent Application Publication
(10) Pub. No.: US 2025/0242900 A1
(43) Pub. Date: Jul. 31, 2025

(54) Underwater Vehicle

(71) Applicant: WESTLAKE UNIVERSITY, Hangzhou, Zhejiang (CN)

(72) Inventors: Wei LI, Hangzhou, Zhejiang (CN); Bing LUO, Hangzhou, Zhejiang (CN); Weicheng CUI, Hangzhou, Zhejiang (CN)

(21) Appl. No.: 18/853,076

(22) PCT Filed: Mar. 29, 2022
(86) PCT No.: PCT/CN2022/083682

§ 371 Date: Sep. 30, 2024

(51) Int. Cl. B63G 8/08; B63G 8/18

(52) U.S. Cl. CPC B63G 8/08; B63G 8/18

(57) ABSTRACT

Embodiments of the present disclosure provide an underwater vehicle, comprising a frame and a driving device; wherein a wing fixing support rod, a wing rotating support rod and a wing tip support rod are provided on the driving device, a first end of the wing fixing support rod and a first end of the wing rotating support rod are movably connected to the driving device, a second end of the wing rotating support rod is movably connected to the wing tip support rod, and at least one main wing rib is provided on the wing fixing support rod and the wing rotating support rod, and at least one wing tip wing rib is sleeved on the wing tip support rod. According to the embodiments of the present disclosure, by providing a plurality of energy storage motor devices, the wing of the underwater vehicle can achieve different individual motions, and a combination of a plurality of individual motions can constitute a complex spatial motion, so that the navigation modes of the underwater vehicle are more diversified, and the biomimetic effect is better.

### TECHNICAL FIELD

Embodiments of the present disclosure relate to the technical field of driving of underwater vehicles, and in particular, to an underwater vehicle.

### BACKGROUND

Regarding existing underwater vehicles, the driving control thereof is often achieved by a separate motor driving a connecting link, so that wings of the underwater vehicle cannot achieve complex motion.

### SUMMARY

In order to solve the described problem, an object of embodiments of the present disclosure is to provide a driving device for an underwater vehicle, and an underwater vehicle, so as to solve the problem existing in the prior art that wings of the underwater vehicle cannot achieve complex motion.

In order to solve the technical problem, embodiments of the present disclosure adopt the following technical solutions:

The present disclosure provides an underwater vehicle, comprising a frame and a driving device, wherein a wing fixing support rod, a wing rotating support rod and a wing tip support rod are provided on the driving device, a first end of the wing fixing support rod and a first end of the wing rotating support rod are movably connected to the driving device, a second end of the wing rotating support rod is movably connected to the wing tip support rod, and at least one main wing rib is provided on the wing fixing support rod and the wing rotating support rod, and at least one wing tip wing rib is sleeved on the wing tip support rod.

In some embodiments, the driving device comprises a first energy storage motor device, a second energy storage motor device, a third energy storage motor device, a fourth energy storage motor device and a crankshaft, wherein a first end of the crankshaft is fixedly connected to the first energy storage motor device, the middle of the crankshaft is connected to the second energy storage motor device, the second energy storage motor device is connected to the third energy storage motor device via a support portion, and the fourth energy storage motor device is arranged at an output end of the third energy storage motor device, and power output directions of the first energy storage motor device, the second energy storage motor device, the third energy storage motor device and the fourth energy storage motor device are different.

In some embodiments, the support portion comprises a base, a circular portion and a fixing frame, the base is provided with a fixing column, the circular portion is sleeved on the fixing column, the fixing column is a hollow structure, and the fixing frame is arranged at an output end of the second energy storage motor device, wherein the base comprises a U-shaped portion and an annular portion, the circular portion and the annular portion are arranged in parallel to each other, the U-shaped portion is connected to the output end of the second energy storage motor device, and the circular portion and the annular portion are respectively sleeved on different positions of the third energy storage motor device.

In some embodiments, any one of the first energy storage motor device, the second energy storage motor device, the third energy storage motor device and the fourth energy storage motor device comprises a motor assembly and a coupling; the motor assembly comprises a motor, an output shaft of the motor is arranged at an output side of the motor assembly, a sliding groove is provided on an end face of the motor assembly, springs are provided in the sliding groove, and one end of the coupling is sleeved on the output shaft and can rotate along with the output shaft, and the other end of the coupling moves in the sliding groove and can compress the springs on the basis of the rotation of the output shaft.

In some embodiments, a connecting portion is provided at a second end of the crankshaft, and the first energy storage motor device and the connecting portion are respectively connected to the frame.

In some embodiments, a first connecting assembly and a second connecting assembly are respectively provided on the frame, the first connecting assembly is connected to the first energy storage motor device, and the second connecting assembly is connected to the connecting portion.

In some embodiments, the third energy storage motor device is fixedly connected to the wing fixing support rod and is movably connected to the wing rotating support rod.

In some embodiments, the first end of the wing rotating support rod is sleeved on a coupling of the output end of the third energy storage motor device, and the wing fixing support rod and the wing rotating support rod are connected to the support portion via a first fixing assembly.

In some embodiments, the fourth energy storage motor device is arranged on the wing rotating support rod.

In some embodiments, one end of the fourth energy storage motor device is fixedly connected to the coupling of the output end of the third energy storage motor device, and the other end of the fourth energy storage motor device is connected to the wing rotating support rod via a second fixing assembly.

In some embodiments, a rotation control portion is provided on a coupling of an output end of the fourth energy storage motor device, and the rotation control portion is connected to the rotation device via a traction device.

In some embodiments, a rotation device is provided between the wing rotating support rod and the wing tip support rod.

In some embodiments, the rotation device comprises a base portion and a joint portion, wherein the base portion is fixedly provided at a second end of the wing rotating support rod, and the base portion comprises two upright columns arranged parallel to each other, a U-shaped support platform is arranged between the upright columns, a rotation shaft is arranged on the support platform, the upright columns are connected to the middle of the rotation shaft, and the joint portion is U-shaped, and two long edges of the joint portion are rotatably connected to the rotation shaft.

In some embodiments, the driving device and the rotation device are connected via a traction device.

In some embodiments, at a position close to the frame, a part of the main wing rib is sleeved on the wing fixing support rod and the wing rotating support rod; and at a position away from the frame, a part of the main wing rib is only sleeved on the wing rotating support rod.

In some embodiments, at a position close to the frame, the wing fixing support rod and the wing rotating support rod are movably connected to the main wing rib in a manner of a wing rib support member and a gear set and/or are movably connected to the main wing rib in a manner of a rotation support, a wing rib support member and a gear set; and at a position away from the frame, the wing rotating support rod is movably connected to the main wing rib in a manner of a wing rib support rod.

Beneficial effects of the embodiments of the present disclosure lie in that: according to the embodiments of the present disclosure, by providing a plurality of energy storage motor devices, the wing of the underwater vehicle can achieve different individual actions, and a combination of a plurality of individual actions can constitute a complex spatial motion, so that the navigation modes of the underwater vehicle are more diversified, and the biomimetic effect is better.

### BRIEF DESCRIPTION OF THE DRAWINGS

In order to describe the technical solutions in the embodiments of the present disclosure or in the prior art more clearly, hereinafter, accompanying drawings requiring to be used for describing the embodiments or the prior art are introduced briefly. Apparently, the accompanying drawings in the following description merely relate to some embodiments disclosed in the present disclosure, and for a person of ordinary skill in the art, other accompanying drawings can also be obtained according to these accompanying drawings without involving any inventive effort.

FIG. 1 is a schematic structural diagram of an underwater vehicle according to embodiments of the present disclosure;

FIG. 2 is a schematic diagram of connection between a frame and a wing in an underwater vehicle according to embodiments of the present disclosure;

FIG. 3 is a schematic structural diagram of a driving unit in an underwater vehicle according to embodiments of the present disclosure;

FIG. 4 is a schematic structural diagram of a frame in an underwater vehicle according to embodiments of the present disclosure;

FIG. 5 is a schematic structural diagram of a crankshaft in a driving device according to embodiments of the present disclosure;

FIG. 6 is a schematic diagram of connection of a driving device according to embodiments of the present disclosure;

FIG. 7 is a schematic diagram of connection of a driving device according to embodiments of the present disclosure;

FIG. 8 is a schematic diagram of connection of a driving device according to embodiments of the present disclosure;

FIG. 9 is a schematic structural diagram of a Rotation device in a driving device according to embodiments of the present disclosure;

FIG. 10 is a schematic diagram showing an arrangement of wing ribs in a driving device according to embodiments of the present disclosure;

FIG. 11 is a schematic structural diagram of a wing rib in a driving device according to embodiments of the present disclosure;

FIG. 12 is a schematic structural diagram of a wing rib in a driving device according to embodiments of the present disclosure;

FIG. 13 is a schematic structural diagram of a wing rib in a driving device according to embodiments of the present disclosure;

FIG. 14 is a schematic structural diagram of wing ribs in a driving device according to embodiments of the present disclosure;

FIG. 15 is a schematic structural diagram of wing ribs in a driving device according to embodiments of the present disclosure;

FIG. 16 is a schematic structural diagram of an energy storage motor device according to embodiments of the present disclosure;

FIG. 17 is an exploded schematic diagram of an energy storage motor device according to embodiments of the present disclosure;

FIG. 18 is a side view of an energy storage motor device according to embodiments of the present disclosure;

FIG. 19 is a schematic diagram of a front cover in an energy storage motor device according to embodiments of the present disclosure;

FIG. 20 is a schematic diagram of a front cover in an energy storage motor device according to embodiments of the present disclosure;

FIG. 21 is a schematic diagram of a rear cover in an energy storage motor device according to embodiments of the present disclosure;

FIG. 22 is a schematic diagram of a rear cover in an energy storage motor device according to embodiments of the present disclosure;

FIG. 23 is a schematic structural diagram of a coupling in an energy storage motor device according to embodiments of the present disclosure; and

FIG. 24 is a side view of a coupling in an energy storage motor device according to embodiments of the present disclosure.

### REFERENCE SIGNS

10—Motor assembly; 1—Front cover; 11—First fixing hole; 12—Sliding groove; 13—First hole; 14—Spring; 2—Coupling; 21—Sleeving portion; 22—Toggle connecting rod; 23—Second hole; 24 Toggle piece; 25—First boss portion; 26—Second boss portion; 27—Third hole; 3—Output shaft; 5—Rear cover; 51—Second fixing hole; 52—Annular portion; 53—Protrusion portion; 54—Line hole; 6—Motor; 100—Frame; 110—First wing; 111—Wing support rod; 112—Body wing rib; 113—Wing tip wing rib; 120—Second wing; 130—Dorsal fin; 140—Tail fin; 150—Platform; 160—First connecting assembly; 170—Second connecting assembly; 200—Driving unit; 210—First energy storage motor device; 220—Second energy storage motor device; 230—Third energy storage motor device; 240—Fourth energy storage motor device; 241—Second fixing assembly; 242—Rotation control portion; 250—Crankshaft; 260—Connecting portion; 270—Support portion; 271—Base; 2711—U-shaped portion; 2712—Annular portion; 272—Circular portion; 273—Fixing column; 274—Connecting rod; 275—First fixing assembly; 276—Fixing frame; 300—Rotation device; 310 Base portion; 311—Upright column; 312—Support platform; 313—Rotation shaft; 320—Joint portion; 400—Traction device; 401—First wing rib; 402—Second wing rib; 403—Third wing rib; 404 Fourth wing rib; 405—Fifth wing rib; 406—First wing rib support rod; 407—First external gear; 408—First internal gear; 409—Second wing rib support rod; 410—Rotation support; 411—Second external gear; 412—Second internal gear; 413—Third wing rib support rod; 414—Second connecting hole; 416—First connecting hole; 501—Sixth wing rib; 502—Seventh wing rib; 503—Eighth wing rib.

### DETAILED DESCRIPTION OF THE EMBODIMENTS

Various solutions and features of the present disclosure are described herein with reference to the accompanying drawings.

It will be appreciated that various modifications can be made to the embodiments as applied herein. Accordingly, the description should not be construed as limiting but merely as exemplifications of the embodiments. A person skilled in the art would have conceived of other modifications within the scope and spirit of the present disclosure.

The accompanying drawings, which are incorporated in the description and constitute a part of the description, illustrate embodiments of the present disclosure, and together with a general description of the present disclosure given above and the detailed description of the embodiments given below, serve to explain the principle of the present disclosure.

These and other features of the present disclosure will become apparent from the following description of preferred forms of embodiment given as non-limiting examples with reference to the accompanying drawings.

It should also be understood that while the present disclosure has been described with reference to specific examples, a person skilled in the art would be able to conclusively implement many other equivalent forms of the present disclosure having the features of the claims and thus all being within the scope of protection defined thereby.

The above and other aspects, features, and advantages of the present disclosure will become more apparent in view of the following detailed description when taken in conjunction with the accompanying drawings.

Hereinafter, specific embodiments of the present disclosure are described with reference to the accompanying drawings. However, it should be understood that the embodiments as applied are merely examples of the present disclosure, which may be implemented in various ways. Well-known and/or duplicate functions and structures have not been described in detail to avoid unnecessary or redundant details which obscure the present disclosure. Therefore, specific structural and functional details as applied herein are not intended for limiting, but merely as a basis and a representative basis for the claims and for teaching a person skilled in the art to diversely use the present disclosure in substantially any suitable detailed structure.

The description may use phrases “in one embodiment”, “in another embodiment”, “in yet another embodiment”, or “in other embodiments”, which may each refer to one or more of the same or different embodiments according to the present disclosure.

Embodiments of the present disclosure provide a multi-degree-of-freedom driving device for an underwater vehicle, which is provided in a biomimetic underwater vehicle in e.g. a fish shape, and the shape of the underwater vehicle may also be selected from other shapes facilitating navigation in water; wherein a wing is provided on at least one side of the underwater vehicle, and navigation of the underwater vehicle in water is achieved by motion of the wing.

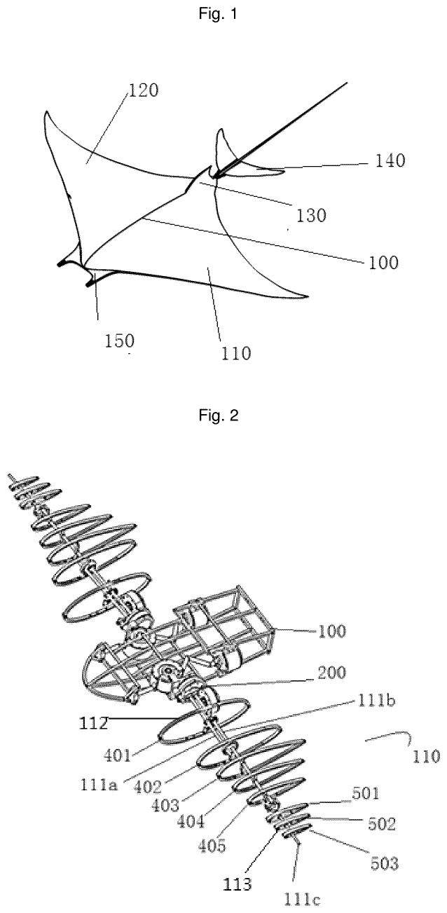

As shown in FIG. 1, FIG. 1 shows an embodiment of the structure of an underwater vehicle. The overall shape of the underwater vehicle is a fish shape, the underwater vehicle comprises a frame 100, a first wing 110 (located on the left side of the frame 100, or referred to as a left wing) and a second wing 120 (located on the right side of the frame 100, or referred to as a right wing) are respectively arranged on two sides of the frame 100, and the first wing 110 and the second wing 120 can be arranged symmetrically with each other. Further, in order to enable the underwater vehicle to mimic, to the greatest extent, for example, a fish, to achieve a navigation function in water, a dorsal fin 130 and a tail fin 140 are provided at the tail of the frame 100, and the navigation attitude and the navigation direction of the underwater vehicle are controlled by the dorsal fin 130 and the tail fin 140. Of course, in order to enable real-time control of the navigation of the underwater vehicle, it is necessary to acquire parameters related to the underwater vehicle during navigation. Thus, various types of sensors for monitoring parameters required for navigation are arranged at the head of the frame 100; furthermore, a fixed platform 150 may be arranged at the head of the frame 100, and the sensors are arranged on the platform 150.

FIG. 2 shows a connection relationship between the frame 100 and the wings in the underwater vehicle, wherein the wings here comprise the first wing 110 located on the left side of the frame 100 and the second wing 120 located on the right side of the frame 100. Here, the first wing 110 located on the left side of the frame 100 is taken as an example for introduction, but this does not limit the scope of protection of the present disclosure.

Specifically, the first wing 110 is movably connected to a side of the frame 100, a driving unit 200 is provided on the frame 100, and the frame 100 is movably connected to the first wing 110 by the driving unit 200, so that the first wing 110 can be driven by the driving unit 200 to achieve various motions. Of course, if the underwater vehicle is configured with a double-wing structure, another driving unit 200 and the second wing 120 movably connected to the driving unit 200 may be provided on the other side of the frame 100, so as to achieve different control on the two wings.

In this way, by using the driving unit(s) 200 arranged on one side or both sides of the frame 100 to drive the first wing 110 and/or the second wing 120 located on the side(s) of the frame 100, a plurality of basic motions, such as at least four basic motions of up and down swing, front and back swing, pitch motion, wing spanwise bending, etc. can be implemented by the wings; and the first wing 110 and/or the second wing 120 located on different sides can be controlled independently of each other. Further, complex motion combinations can also be achieved by different wings, that is, the configuration of the two wings can achieve diversified motion modes of the underwater vehicle, thereby realizing high-motion performance of the underwater vehicle. In addition, the driving unit 200 and the wing are connected compactly, and are arranged on the side of the frame 100 of the underwater vehicle in a centralized manner, thereby reducing the quality of a moving portion of the wing and the rotational inertia of the wing, and making the motion of the wing more flexible.

With reference to FIG. 2, the structure of the first wing 110 is introduced by taking the first wing 110 located on the left side of the frame 100 as an example, the first wing 110 comprises a wing fixing support rod 111a, a wing rotating support rod 111b and a wing tip support rod 111c, wherein at least one main wing rib 112 is sleeved on the wing fixing support rod 111a and the wing rotating support rod 111b, and at least one wing tip wing rib 113 is sleeved on the wing tip support rod 111c. Of course, in order to achieve coverage by the wing ribs, the number of the main wing ribs 112 and the wing tip wing ribs 113 may be plural. Here, the shape and structure of the main wing ribs 112 are similar to the shape and structure of the wing tip wing ribs 113, both comprising an upper arc-shaped member and a lower arc-shaped member, and the upper arc-shaped member and the lower arc-shaped member being assembled with each other to form a wing rib structure.

Further, on either side of the frame 100, a first end of the wing fixing support rod 111a and a first end of the wing rotating support rod 111b are movably connected to the driving unit 200 on the frame 100, and a second end of the wing rotating support rod 111b is movably connected to the wing tip support rod 111c; in this way, the driving unit 200 can drive the motion of the wing rotating support rod 111b and the wing tip support rod 111c, so as to drive the motion of the main wing ribs 112 and the wing tip wing ribs 113.

Specifically, continuing to refer to FIG. 2, in order to facilitate the control of the motion of the wing tip wing ribs 113, a rotation device 300 is further arranged between the wing rotating support rod 111b and the wing tip support rod 111c, and the second end of the wing rotating support rod 111b is connected to the wing tip support rod 111c via the rotation device 300; in this way, the rotation device 300 can drive the wing tip wing ribs 113 to achieve motions such as rotation relative to the main wing ribs 112, and the rotation device 300 herein acts as a wing tip rotation joint. Further, in order to ensure the motion control on the wing tip wing ribs 113, the driving unit 200 and the rotation device 300 are also connected via a traction device 400, and the traction device 400 here may be, for example, a rope or a connecting rod for driving the wing tip rotation joint.

In this way, in the underwater vehicle involved in the embodiments of the present disclosure, the sequence of connection of components between the frame 100 and the first wing 110 is as follows: the driving unit 200 is connected to the wing fixing support rod 111a and the wing rotating support rod 111b, the wing rotating support rod 111b is connected to the rotation device 300, the rotation device 300 is connected to the wing tip support rod 111c, the main wing ribs 112 are sleeved on the wing fixing support rod 111a and the wing rotating support rod 111b, and the wing tip wing ribs 113 are sleeved on the wing tip support rod 111c.

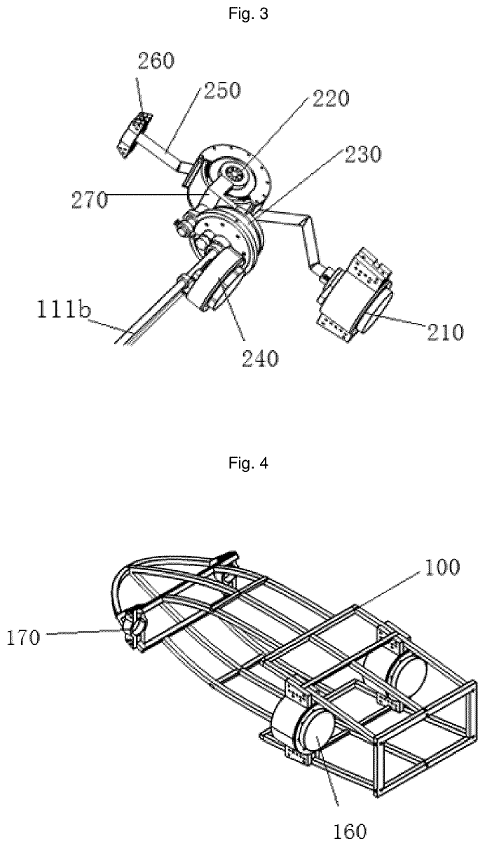

FIG. 3 shows a perspective structure of the driving unit 200 in the underwater vehicle; and FIG. 4 shows a perspective structure of the frame 100. According to FIG. 3 combined with FIG. 4, the driving unit 200 is arranged on the frame 100, wherein the driving unit 200 comprises a first energy storage motor device 210, a second energy storage motor device 220, a third energy storage motor device 230, a fourth energy storage motor device 240 and a crankshaft 250; each energy storage motor device herein comprises a driving device, the driving device herein may use a motor assembly, the motor assembly comprises a motor for outputting power and a sealing sleeve, the sealing sleeve is used for packaging and accommodating the motor, and a coupling is provided on an output shaft of the motor assembly. The structure of the motor assembly will be expanded in the following description.

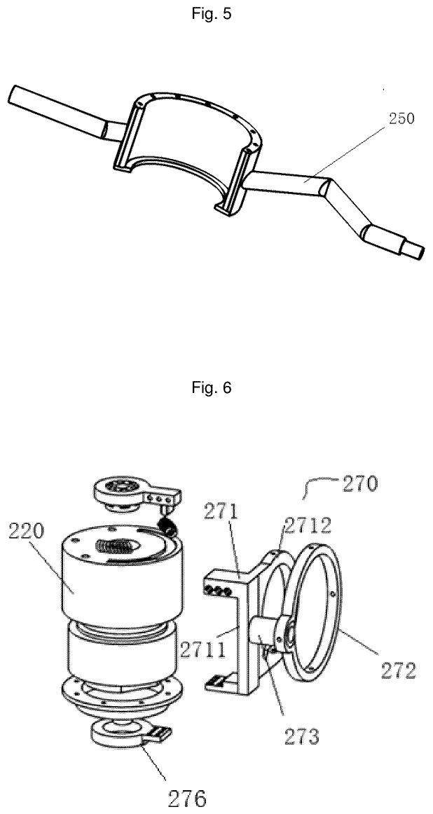

Specifically, the crankshaft 250 is fixedly connected to the frame 100, wherein the structure of the crankshaft 250 is as shown in FIGS. 3 and 5, a first end of the crankshaft 250 is fixedly connected to the first energy storage motor device 210, and a second end of the crankshaft 250 is provided with a connecting portion 260, so that the first energy storage motor device 210 can drive rotation of the crankshaft 250; and a middle portion of the crankshaft 250 is connected to the second energy storage motor device 220. In this way, the second energy storage motor device 220 is arranged on the crankshaft 250, the second energy storage motor device 220 is connected to the third energy storage motor device 230 via a support portion 270, the third energy storage motor device 230 is fixedly connected to the wing fixing support rod 111a and movably connected to the wing rotating support rod 111b, and the fourth energy storage motor device 240 is provided on the wing rotating support rod 111b; wherein power output directions of the first energy storage motor device 210, the second energy storage motor device 220, the third energy storage motor device 230 and the fourth energy storage motor device 240 are different, so that the first wing 110 can achieve motion in different directions by determination of different energy storage motor devices. Preferably, the power output directions of the first energy storage motor device 210, the second energy storage motor device 220, the third energy storage motor device 230 and the fourth energy storage motor device 240 are perpendicular to each other.

It should be noted that the first energy storage motor device 210, the second energy storage motor device 220, the third energy storage motor device 230 and the fourth energy storage motor device 240 have the same structure and function; in the embodiments of the present disclosure, the specific structure of the energy storage motor device is introduced by taking the first energy storage motor device 210 as an example. The motor energy storage device here can be widely applied to the situation of reciprocating rotation of a motor, and can be particularly used for the motion control of a biomimetic underwater vehicle, for example, in the motion of the biomimetic underwater vehicle, the up and down swing of the wings thereof is realized by reciprocating rotation of a driving device such as a motor. In this process, reciprocating rotation in two directions is achieved at an output end of the motor by means of forward rotation or reverse rotation of the motor, and when the output end moves in one direction and direction change is required, braking and deceleration are required. According to the embodiments of the present disclosure, a braking effect can be achieved when direction change of the motor is performed during motion of the output end, and kinetic energy can be stored and released.

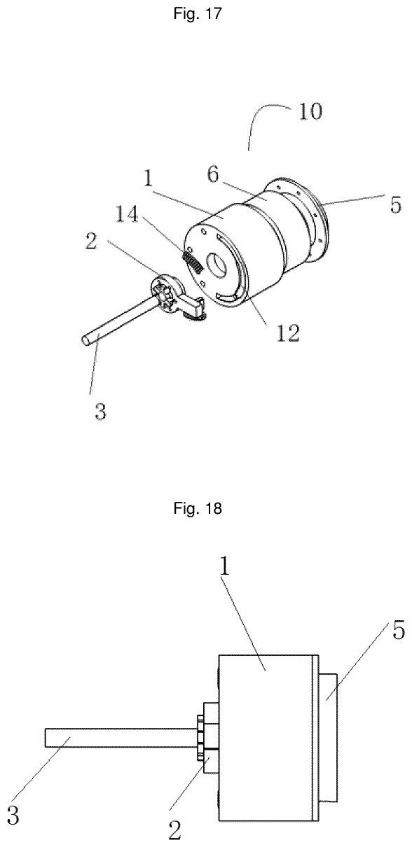

As shown in FIGS. 16-18, FIGS. 16-18 show the energy storage motor devices of the present embodiment, in which FIG. 16 shows a perspective schematic diagram of the energy storage motor device, FIG. 17 is an exploded view of the energy storage motor device, and FIG. 18 shows a side view of the energy storage motor device. Specifically, the energy storage motor device comprises a driving device, the driving device herein may use a motor assembly 10, the motor assembly 10 comprises a motor 6 for outputting power and a sealing sleeve; wherein the sealing sleeve is used for packaging and accommodating the motor 6, the motor 6 can be stably fixed in the sealing sleeve and can rotate in different directions, such as clockwise or counterclockwise, so as to output kinetic energy. In order to facilitate fixing of the motor 6 in the sealing sleeve, specifically, the sealing sleeve comprises a front cover 1 and a rear cover 5, and the shapes of the front cover 1 and the back cover 5 are not specifically limited herein, as long as after the front cover 1 and the rear cover 5 are closed, the motor 6 can be stably fixed in the sealing sleeve. Preferably, when the motor 6 is packaged by the sealing sleeve, the front cover 1 is located at an output side of the motor assembly, so that an output component of the motor 6 extends out of the sealing sleeve, that is, kinetic energy of the motor 6 in the motor assembly is outputted from the direction of the front cover 1. In particular, when the underwater vehicle is used for underwater navigation, the sealing sleeve can seal the motor 6 below water.

In a specific embodiment, the front cover 1 may be in a cylinder shape having one side sealed and the other side open, the cylinder shape matches the shape of a housing of the motor 6, so that the motor 6 is fixedly accommodated in the front cover 1; and the rear cover 5 is of a flat cover shape, and the rear cover 5 can cover the opening, so as to cover on the front cover 1 to form the sealing sleeve, to package the motor 6.

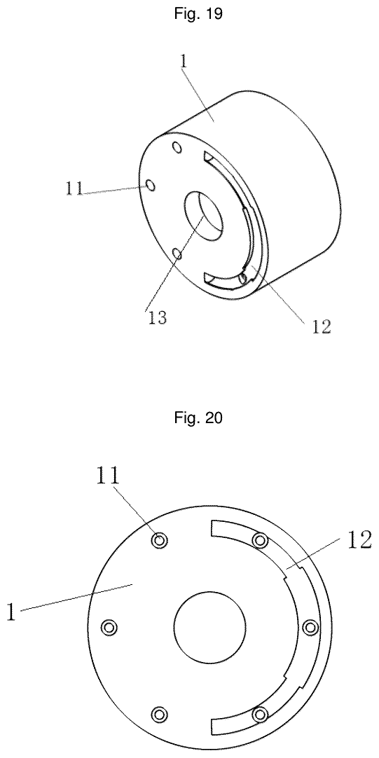

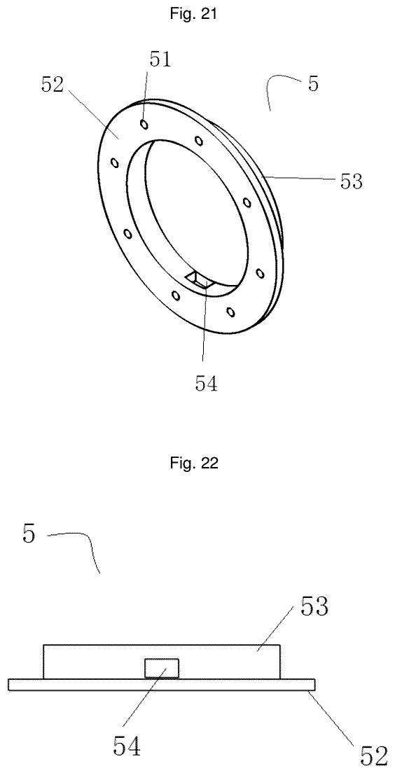

Further, FIG. 19 shows a perspective view of the front cover 1, FIG. 20 shows a front view of the front cover 1, FIG. 21 shows a perspective view of the rear cover 5, and FIG. 22 shows a side view of the rear cover 5. With reference to FIGS. 16-18 and in conjunction with FIGS. 19-22, in order to achieve the packaging effect of the sealing sleeve on the motor 6, first fixing holes 11 are provided on an end face of the front cover 1, and second fixing holes 51 are provided on an end face of the rear cover 5, and by fitting of the first fixing holes 11, the second fixing holes 51 and screws, for example, after the motor 6 is fixed in the sealing sleeve, the sealing sleeve achieves packaging of the motor.

Further, as the rear cover 5 covers the front cover 1 to form the sealing sleeve to package the motor 6, the rear cover 5 comprises an annular portion 52, the annular portion 52 is in contact with and connected to the end face of the front cover 1, and the second fixing holes 51 may be provided on the annular portion 52. In addition, a protrusion portion 53 is arranged on the inner side of the annular portion 52, and the protrusion portion 53 is arranged in a direction away from the front cover 1, and preferably, the protrusion portion 53 may be arranged perpendicular to the annular portion 52. Considering that the kinetic energy of the motor assembly in the sealing sleeve is outputted from the direction of the front cover 1, a power supply line, a control line, etc. of the motor 6 are arranged from the direction of the rear cover 5, and the power supply line, the control line, etc. used by the motor 6 need to extend into the motor assembly from the outside of the motor assembly and be connected to the motor 6. To this end, a line hole 54 is provided on the protrusion portion 53, and the line hole 54 is used for passing through of the power supply line, the control line, etc. used by the motor 6, and connection thereof to the motor 6.

Further, as shown in FIGS. 16-18, the motor 6 as the driving device has an output shaft 3, the motor 6 outputs power through the output shaft 3; the output shaft 3 is mounted at an output side of the motor assembly, passes through and extends out of the sealing sleeve of the motor assembly 10, and in particular, passes through the front cover 1 of the sealing sleeve, for example, the front cover 1 may be provided with a through hole to facilitate passing through of the output shaft 3. A coupling 2 is provided on the output side of the motor assembly, the coupling 2 is associated with the motion of the wing, for example, the coupling 2 is specifically located on the outer side of the motor assembly, especially on the outer side of the front cover 1, and the coupling 2 is fixedly sleeved on the output shaft 3, and can rotate along with the rotation of the output shaft 3. Specifically, a first hole 13 is provided on the motor assembly, especially on the front cover 1, and a part of the coupling 2 is fixed to the motor 6 in the motor assembly 10 by passing through the first hole 13.

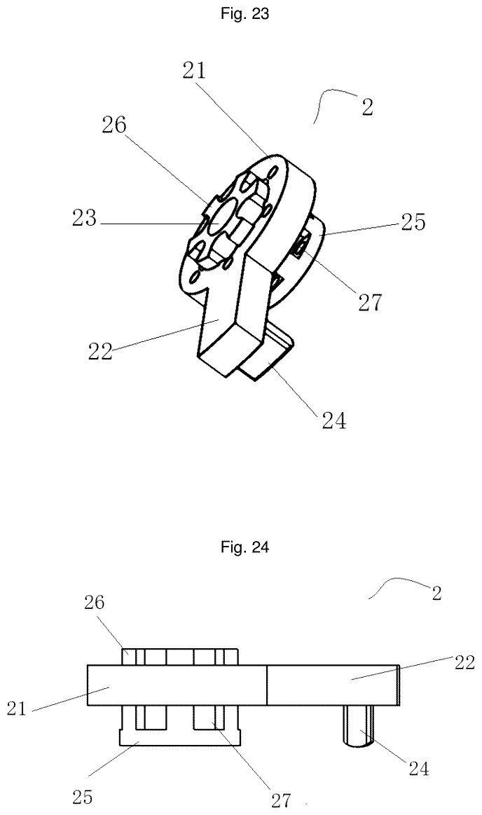

Further, as shown in FIGS. 23 and 24, FIG. 23 shows a schematic diagram of a perspective structure of the coupling 2, and FIG. 24 shows a side view of the coupling 2. The coupling 2 comprises a sleeving portion 21 and a toggle connecting rod 22, the sleeving portion 21 can be integrally made with the toggle connecting rod 22, and the sleeving portion 21 is connected to the output shaft 3; in order to facilitate connection to the output shaft 3, the sleeving portion 21 may be in a disc shape, and specifically, a second hole 23 matching with the output shaft 3 is provided in the sleeving portion 21, and the output shaft 3 passes through the second hole 23 so that the coupling 2 is fixedly provided on the output shaft 3. Further, a proximal end of the toggle connecting rod 22 is connected to the sleeving portion 21, a distal end of the toggle connecting rod 22 is provided with a toggle piece 24, and the toggle piece 24 is arranged on a first side surface of the toggle connecting rod 21 facing the front cover 1 and is perpendicular to the toggle connecting rod 22. In this way, the sleeving portion 21 can be sleeved on the output shaft 3 and can rotate coaxially with the output shaft 3, and thus when the sleeving portion 21 rotates along with the rotation of the output shaft 3, the sleeving portion 21 drives the toggle piece 24 to rotate via the toggle connecting rod 22, and thus the kinetic energy outputted by the motor assembly 10 can be transferred to the toggle connecting rod 22.

Considering that the coupling 2 is arranged on the outer side of the front cover 1, the toggle piece 24 is arranged on a first side face of the toggle connecting rod 22 facing towards the front cover 1, and further, since the kinetic energy of the output shaft 3 is transferred to the toggle connecting rod 22 along with the rotation of the coupling 2, in order to store and release the kinetic energy, as shown in FIGS. 16 and 17, a sliding groove 12 is provided on an outer side surface of the motor assembly 10, and the sliding groove 12 can be specifically provided on the end face of the front cover 1 of the sealing sleeve, the sliding groove 12 is used for accommodating the toggle piece 24; and the shape of the sliding groove 12 herein matches the shape of the front cover 1, and is used for coordinating the motion of the toggle piece 24, so that the toggle piece 24 can be inserted into the sliding groove 12, and moves in the sliding groove 12 along with the rotation of the toggle piece 24, and correspondingly, the shape of the toggle piece 24 matches the shape of the cross section of the sliding groove 12.

Further, the length of the sliding groove 12 can be determined according to the motion range of the toggle piece 24, that is, the toggle piece 24 moves within the range of the sliding groove 12, and the motion range of the toggle piece 24 is determined on the basis of the swing range of the wing, and also is determined on the basis of the forward rotation range or reverse rotation range of the motor 6. Here, correspondingly, the sliding groove 12 has a certain range, and two ends thereof are two endpoints of the motion range of the toggle piece 24; the toggle piece 24 moves along with the rotation of the output shaft 3 of the motor assembly 10, and the motion trajectory of the toggle piece is arc-shaped, and thus the shape of the sliding groove 12 herein may be set to be arc-shaped, for example, so that the toggle piece 24 can move along the arc-shaped sliding groove 12.

Further, as the toggle piece 24 moves within a certain range in the sliding groove 12, springs are provided in the sliding groove 12, so that the toggle piece 24 can compress the springs when moving in the sliding groove 12, so as to achieve a braking effect by the springs and achieve storage of kinetic energy by compression of the springs; in this way, the kinetic energy is stored while the toggle 24 compresses the springs, and the elastic potential energy is converted into the kinetic energy for the rotation of the motor 6 while releasing the springs. For example, a notch may be provided at the middle of the sliding groove 12 to facilitate installation of the springs. Specifically, considering that the motor 6 can rotate in forward and reverse directions, such that the output shaft 3 can rotate in two directions, and finally the toggle piece 24 can rotate in two directions, for example, clockwise and anticlockwise directions, two ends of the sliding groove 12 are respectively end points of the motion of the toggle piece 24 when the motor 6 rotates in forward and reverse directions, and if the toggle piece 24 continues to move, the toggle piece will contact and damage the motor 6, and thus the toggle piece 24 needs to perform braking and kinetic energy storage when moving to the two ends. To this end, springs 14 are fixedly provided at the two ends respectively, and the toggle piece 24 can reciprocate in the sliding groove 12 and can compress the springs 14 located at the two ends of the sliding groove 12 respectively when the motor 6 rotates in forward and reverse directions; thus, the springs 14 at the two ends can be compressed by the toggle piece 24 during the rotation of the motor 6 in both directions, to respectively achieve braking and kinetic energy storage, and the kinetic energy is stored while the toggle 24 compresses the spring 14, and the elastic potential energy is converted into the kinetic energy for the rotation of the motor 6 while releasing the springs 14. In addition, the motor 6 can be braked at the tail end of the reciprocating rotation, i.e. at the limit position of compression of the spring 14, and can quickly rotate reversely, thereby satisfying the requirement of high-frequency reciprocating rotation of the motor, and saving energy. The length of the spring 14 in a natural state, i.e. a compression stroke of the spring 14, can be determined according to requirements. If the length of the sliding groove 12 is greater than a sum of natural lengths of the springs 14 at two ends of the sliding groove 12, it means that an empty stroke exists, that is, the springs 14 are not compressed in the empty stroke.

Further, with continued reference to FIGS. 23 and 24, in order to facilitate the installation of the coupling 2 on the output shaft 3, a first boss portion 25 is provided on a first side of the sleeving portion 21 facing the front cover 1, and a second boss portion 26 is provided on a second side of the sleeving portion 21 away from the front cover 1; the first boss portion 25 and the second boss portion 26 are used to enhance the connection strength between the coupling 2 and the output shaft 3, and the shape of the first boss portion 25 matches the shape of the first hole 13, and thus the first boss portion passes through the first hole 13; the first boss portion 25 is provided with at least one third hole 27, and the first boss portion 25 is connected to the housing of the motor 6 of the motor assembly 10 through the third hole 27. In addition, a keyway structure may be further provided between the second boss portion 26 and the output shaft 3, to ensure that the coupling 2 and the output shaft 3 rotate coaxially.

By using the energy storage motor devices according to the embodiments of the present disclosure, operation is achieved in the following way:

under driving by the motor 6 in the motor assembly, the coupling 2 drives the output shaft 3 to rotate; the coupling 2 transfers the kinetic energy to the toggle piece 24 via the toggle connecting rod 22, wherein the radius of curvature of the motion of the toggle piece 24 is consistent with the radius of curvature of the sliding groove 12, such that the toggle piece 24 can slide smoothly in the sliding groove 12; wherein a notch is provided in the middle position of the sliding groove, and the diameter of the notch is slightly greater than the diameter of the springs 14, thereby ensuring that the springs 14 are easy to install and can be axially pushed to an end of the sliding groove 12 for fixation; in this way, it is ensured that the springs 14 always perform a compression and restoration motion in the sliding groove 12 after being in contact with the toggle piece 24, and the situations of circumferential movement or falling out of the sliding groove 12 will not occur.

The embodiments of the present disclosure are used in conjunction with the control of a driving device, for example, can be used in the operation of a biomimetic underwater vehicle, and the working flow is as follows: in the process of an empty stroke, when the motor 6 is powered on for driving, an external load is driven to operate, and when the toggle piece 24 is about to contact the motor 14 by means of rotation, the motor 6 can be powered off, and the motion continues depending on the inertia of the load, so that the toggle piece 24 compresses the spring 14, converts most of the kinetic energy of the load into elastic potential energy of the spring 14 for storage, thereby achieving braking; and when the spring 14 is compressed to the shortest point, the current of the motor goes reverse, at this time, the elastic potential energy of the spring 14 is also released, so that a rotor in the motor 6 has a torque greater than the simple reverse current in the case of the same load, which is directly embodied as faster reverse acceleration. It is advantageous in reciprocating motion of most biomimetic machines. The design of the energy storage and braking structure of a driving motor can enable the motor to quickly rotate reversely at a limiting position of the reciprocating rotation stroke, satisfying the requirements of high-frequency reciprocating motion and saving energy, thereby achieving the requirements of high-frequency swing of an output end.

Further, as shown in FIG. 4, in order to enable the crankshaft 250 to be fixedly connected to the frame 100, the first energy storage motor device 210 located at the first end of the crankshaft 250 and the connecting portion 260 located at the second end of the crankshaft 250 are respectively connected to the frame 100, wherein in order to facilitate connection between the first energy storage motor device 210 and the frame 100, a first connecting assembly 160 and a second connecting assembly 170 may be arranged on the frame 100, respectively, wherein the first connecting assembly 160 is connected to a sealing sleeve housing of the first energy storage motor device 210, and an output shaft of the first energy storage motor device 210 is connected to the crankshaft 250 via a crankshaft coupling. The second connecting assembly 170 is connected to the connecting portion 260, so that the crankshaft 250 is connected to the frame 100, and thus the driving unit 200 can be fixed on the frame 100. The connecting portion 260 herein may be a rolling bearing support, and certainly may also be a motor; in this way, although the degree of freedom is not changed, the driving force of the degree of freedom can be increased. In addition, in order to connect the middle of the crankshaft 205 to the second energy storage motor device 220, as shown in FIG. 3, the crankshaft 205 and a sealing sleeve of the second energy storage motor device 220 can be integrally formed.

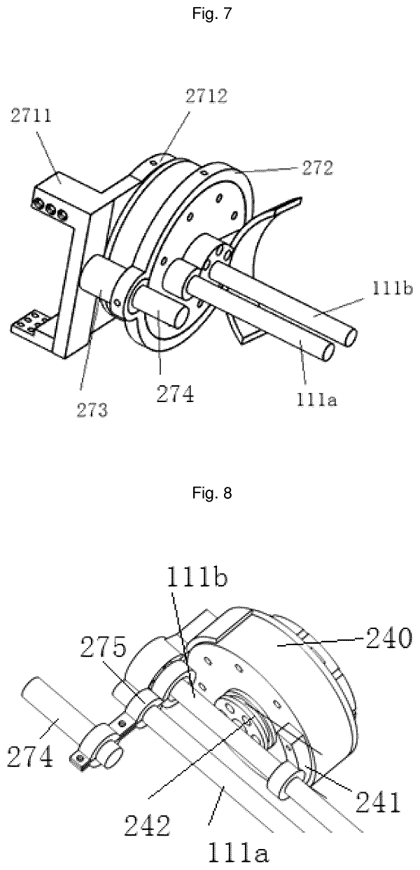

As stated above, the second energy storage motor device 220 is connected to the third energy storage motor device 230 via the support portion 270. As shown in FIGS. 2, 6 and 7, the support portion 270 comprises a base 271, a circular portion 272 and a fixing frame 276, wherein the base 271 is provided with a fixing column 273, and the circular portion 272 is sleeved on the fixing column 273 so as to be arranged on the base 271, and the fixing column 273 is a hollow structure in which a connecting rod 274 can be inserted, wherein the base 271 comprises a U-shaped portion 2711 and an annular portion 2712, the circular portion 272 and the annular portion 2712 are arranged in parallel to each other, and the U-shaped portion 2711 and the second energy storage motor device 220 are clamped to each other. Specifically, the fixing frame 276 is connected to an output shaft of the second energy storage motor device 220, and two long edges of the U-shaped portion 2711 are respectively connected to a coupling of an output end of the second energy storage motor device 220 and the fixing frame 276, so that the support portion 270 can rotate along with the rotation of the coupling of the second energy storage motor device 220, the circular portion 272 and the annular portion 2712 are respectively sleeved at different positions on a sealing sleeve of the third energy storage motor device 230, and thus the third energy storage motor device 230 can be arranged on the support portion 270, and then can be arranged on the second energy storage motor device 220 via the support portion 270. Therefore, the third energy storage motor device 230 can be arranged on the crankshaft 250, and when the second energy storage motor device 220 rotates, the support portion 270 drives the third energy storage motor device 230 to rotate.

In this way, during installation, a motor in the second energy storage motor device 220 is fixedly connected to a front cover of a sealing sleeve, a rear cover of the sealing sleeve is fixedly connected to the front cover, the fixing frame 276 is connected to a rotation shaft on the rear cover of the sealing sleeve in the second energy storage motor device 220, springs in the second energy storage motor device 220 are respectively fixedly connected to a sliding groove in an end face of the front cover; and a coupling and a toggle piece are fixedly connected to an output end of the second energy storage motor device 220, the toggle piece is arranged in the sliding groove of the front cover, and two ends of the support portion 270 are fixedly connected to the coupling and toggle piece of the second energy storage motor device 220 and the fixing frame 276, respectively. The third energy storage motor device 230 is fixedly connected to the support portion 270, the connecting rod 274 of the support portion 270 is connected to the fixing column 273, a coupling of the third energy storage motor device 230 is fixedly connected to an output shaft of the third energy storage motor device 230, the wing rotating support rod 111b is connected to the coupling of the third energy storage motor device 230, and the wing fixing support rod 110a is arranged on the third energy storage motor device 230.

Further, as shown in FIG. 8, a first end of the wing rotating support rod 111b is sleeved on the coupling of an output end of the third energy storage motor device 230; the wing rotating support rod 111b, the wing fixing support rod 111a and the connecting rod 274 inserted into the fixing column 273 are connected to each other via a first fixing assembly 275, such that the wing rotating support rod 111b and the wing fixing support rod 111a are fixedly arranged relative to the position of the support portion 270. In this way, the third energy storage motor device 230 can drive the wing rotating support rod 111b to rotate.

Further, as shown in FIG. 8, the fourth energy storage motor device 240 is provided on the wing rotating support rod 111b, one end of the fourth energy storage motor device 240 is fixedly connected to the coupling of the output end of the third energy storage motor device 230, and the other end of the fourth energy storage motor device is connected to the wing rotating support rod 111b via a second fixing assembly 241, so that the fourth energy storage motor device 240 can rotate along with the rotation of the third energy storage motor device 230, a rotation control portion 242 is provided on a coupling of an output end of the fourth energy storage motor device 240, and the rotation control portion 242 is connected to the rotation device 300 via the traction device 400, so as to control the motion of the wing tip support rod 111c.

In this way, during installation, a side wall of the fourth energy storage motor device 240 is tightly attached to and fixedly connected to an arc-shaped part of the coupling of the third energy storage motor device 230, the second fixing assembly 241 is connected to the wing rotating support rod 111b, an end face of an output shaft of the fourth energy storage motor device 240 is fixedly connected to the second fixing assembly 241, the second fixing assembly 241 is connected to the connecting rod 274 of the support portion 270 and is connected to the wing rotating support rod 111b by a rolling bearing, the rotation control portion 242 is fixedly connected to the output shaft of the fourth energy storage motor device 240, and the traction device 400 is wound on the rotation control portion 242.

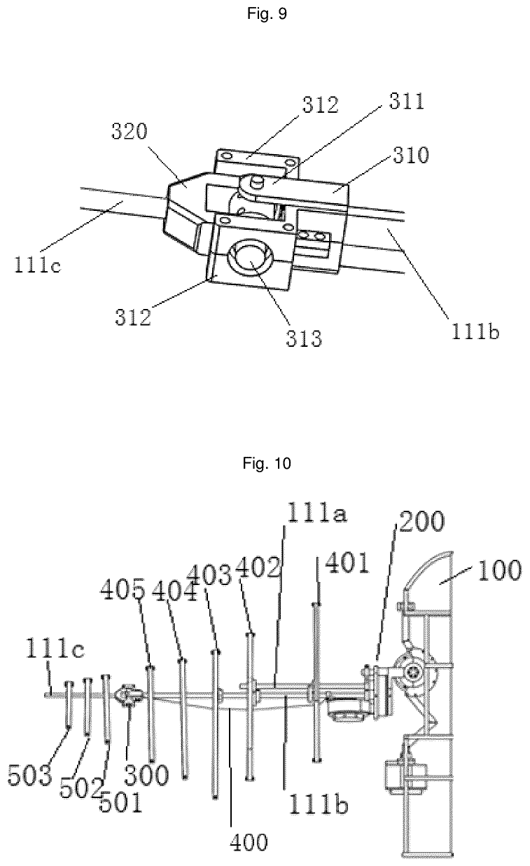

As shown in FIG. 9, FIG. 9 shows a schematic structural diagram of the rotation device 300 and a connection relationship between the rotation device and the wing rotating support rod 111b and the wing tip support rod 111c according to embodiments of the present disclosure. The rotation device 300 comprises a base portion 310 and a joint portion 320, wherein the base portion 310 is fixedly provided at the second end of the wing rotating support rod 111b, and the base portion 310 comprises two upright columns 311 arranged parallel to each other, a U-shaped support platform 312 is arranged between the upright columns 311, a rotation shaft 313 is arranged on the support platform 312, the upright columns 311 are connected to the middle of the rotation shaft 313, and the joint portion 320 is U-shaped, and two long edges of the joint portion are rotatably connected to the rotation shaft 313. In this way, the joint portion 320 can achieve swinging.

As described above, at least one main wing rib 112 is sleeved on the wing fixing support rod 111a and the wing rotating support rod 111b, and at least one wing tip wing rib 113 is sleeved on the wing tip support rod 111c, as shown in FIG. 10 combined with FIG. 2, wherein at a position close to the frame 100, a part of the main wing rib 112 is sleeved on the wing fixing support rod 111a and the wing rotating support rod 111b, and at a position away from the frame 100, a part of the main wing rib 112 is only sleeved on the wing rotating support rod 111b; and wherein at a position close to the frame 100, the wing fixing support rod 111a and the wing rotating support rod 111b can be movably connected to the main wing rib 112 in a manner of a wing rib support member and a gear set, and can also be movably connected to the main wing rib 112 in a manner of a rotation support, a wing rib support member and a gear set; in addition, at a position away from the frame 100, the wing rotating support rod 111b can be movably connected to the main wing rib 112 in a manner of a wing rib support rod.

As shown in FIG. 10, in one embodiment, a first wing rib 401, a second wing rib 402, a third wing rib 403, a fourth wing rib 404, a fifth wing rib 405, a sixth wing rib 501, a seventh wing rib 502 and an eighth wing rib 503 are sequentially arranged on the first wing 110, wherein the first wing rib 401, the second wing rib 402, the third wing rib 403, the fourth wing rib 404 and the fifth wing rib 405 all belong to the main wing ribs 112, and the sixth wing rib 501, the seventh wing rib 502 and the eighth wing rib 503 all belong to the wing tip wing ribs 113, wherein the lengths of the different main wing ribs 112 and wing tip wing ribs are determined according to the shape of the simulated wing. For example, the lengths from the first wing rib 401 to the eighth wing rib 503 may be decreased gradually.

The first wing rib 401 is closest to the frame 100 and the eighth wing rib 503 is farthest from the frame 100; the first wing rib 401 and the second wing rib 402 are sleeved on both the wing fixing support rod 111a and the wing rotating support rod 111b, and the third wing rib 403, the fourth wing rib 404 and the fifth wing rib 405 are sleeved on the wing rotating support rod 111b. In addition, the sixth wing rib 501, the seventh wing rib 502 and the eighth wing rib 503 are sleeved on the wing tip support rod 111c.

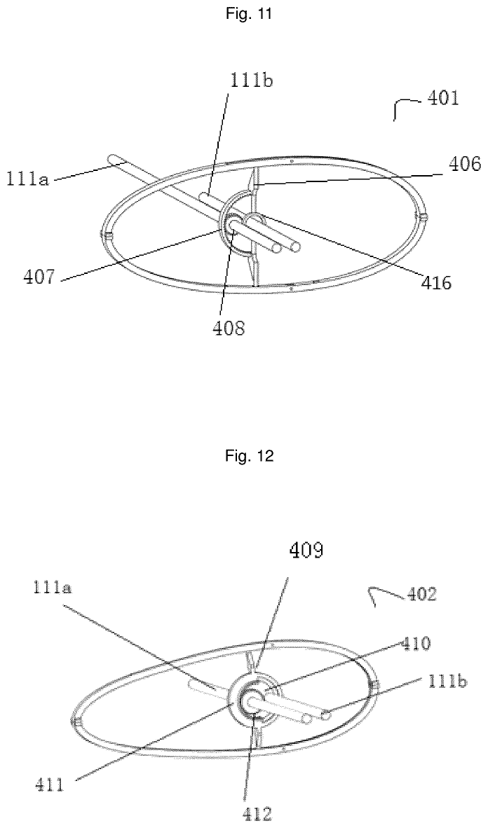

Further, as shown in FIG. 11, a first wing rib support rod 406 is provided on the first wing rib 401, a first connection hole 416 and a first external gear 407 are provided on the first wing rib support rod 406, wherein the wing rotating support rod 111b passes through the first connection hole 416, and a first internal gear 408 is sleeved on the wing fixing support rod 111a, and the first internal gear 408 and the first external gear 407 are in engaged transmission with each other.

As shown in FIG. 12, a second wing rib support rod 409 is provided on the second wing rib 402, and a rotation support 410 is provided on the second wing rib support rod 409, wherein the wing rotating support rod 111b passes through the rotation support 410 and is fixedly connected to the rotation support 410, a second external gear 411 is provided on the rotation support 410, and a second internal gear 412 is sleeved on the wing fixing support rod 111a, and the second internal gear 412 and the second external gear 411 are in engaged transmission with each other.

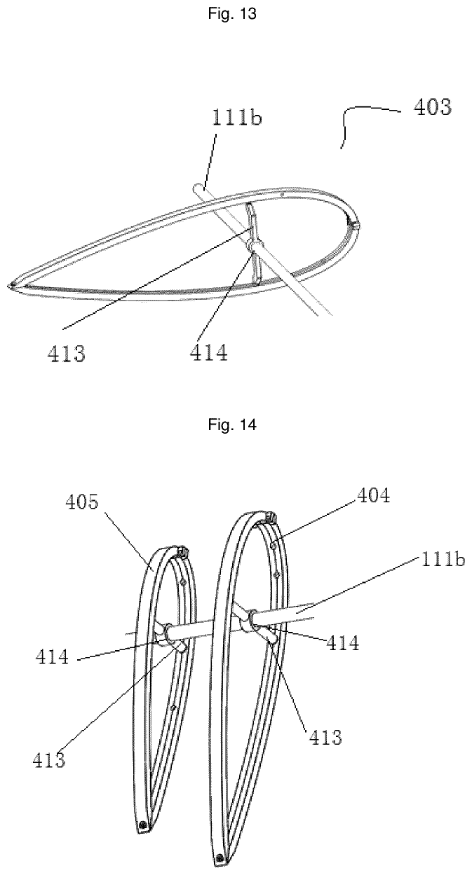

As shown in FIGS. 13 and 14, a third wing rib support rod 413 is provided on each of the third wing rib 403, the fourth wing rib 404 and the fifth wing rib 405, a second connection hole 414 is provided on each third wing rib support rod 413, and the wing rotating support rod 111b respectively passes through the second connection hole 414 on each wing rib.

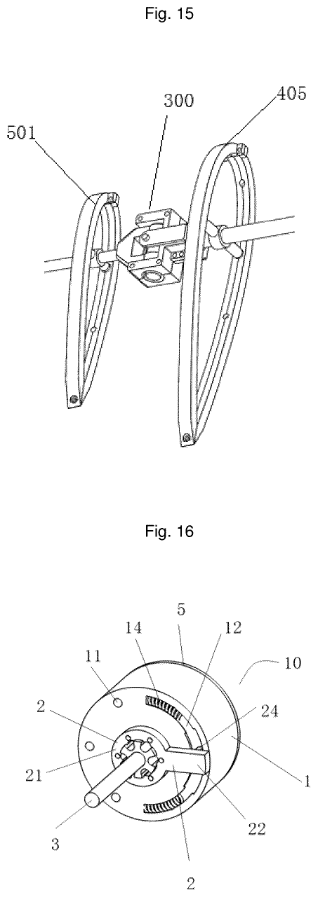

As shown in FIG. 15, for the manner in which the sixth wing rib 501, the seventh wing rib 502 and the eighth wing rib 503 are sleeved on the wing tip support rod 111c, reference can be made to the manner in which the third wing rib 403, the fourth wing rib 404 and the fifth wing rib 405 are sleeved on the wing rotating support rod 111b.

The multi-degree-of-freedom driving device involved in the embodiments of the present disclosure can enable the underwater vehicle to achieve complex motions on the basis of changes of the wings. In the underwater vehicle having a double-wing configuration, the first wing 110 and the second wing 120 are symmetrically arranged, and therefore the basic motion situations thereof are all the same. Considering that complex motions are superposition of basic motions, only the basic motions of a single wing are introduced here. Moreover, these basic motions are independent of each other, and a combination of a plurality of motions can constitute a complex spatial motion of a single wing, and further combination thereof can constitute a complex motion of two wings, thereby realizing a multi-degree-of-freedom complex motion of the underwater vehicle of the embodiments of the present disclosure.

Hereinafter, the motion of the first wing 110 is taken as an example, in which the first wing 110 is driven by four energy storage motor devices together, and therefore there are four basic motions for a single wing, which are respectively:

### (1) Up and Down Swing of the Wing:

Here, the up and down swing of the wing is driven by the first energy storage motor device 210 to generate a reciprocating rotational motion, the angle of the reciprocating motion is limited by the length of the sliding groove and the maximum compression limit of the springs which are arranged on the end face of the front cover of the sealing sleeve in the first energy storage motor device 210; the crankshaft 250 transfers the reciprocating rotational motion of the first energy storage motor device 210 to the second energy storage motor device 220 to achieve up and down swing; the third energy storage motor device 230 transfers the up and down swing motion to the wing fixing support rod 111a, the wing rotating support rod 111b and the fourth energy storage motor device 240 via the connecting rod 274, the wing fixing support rod 111a and the wing rotating support rod 111b transfer the up and down swing to the first wing rib 401, the second wing rib 402, the third wing rib 403, the fourth wing rib 404 and the fifth wing rib 405. In addition, the wing rotating support rod 111b transfers the up and down swing motion to the wing tip support rod 111c via the Rotation device 300, and the wing tip support rod 111c transfers the up and down swing motion to the sixth wing rib 501, the seventh wing rib 502 and the eighth wing rib 503 via the wing rib support rods.

### (2) Pitch Motion of the Wing:

The pitch motion of the wing herein is driven by the third energy storage motor device 230, the third energy storage motor device 230 transfers the reciprocating rotational motion to the wing rotating support rod 111b, and the wing rotating support rod 111b transfers the reciprocating rotational motion to the wing tip support rod 111c via the Rotation device 300; the wing rotating support rod 111b and the wing tip support rod 111c directly transfer the reciprocating rotational motion of the third energy storage motor device 230 to the third wing rib 403, the fourth wing rib 404, the fifth wing rib 405, the sixth wing rib 501, the seventh wing rib 502 and the eighth wing rib 503 via the wing rib support rods, such that the reciprocating rotational motion of the third energy storage motor device 230 is directly converted into pitch motion corresponding to the main wing ribs 112 and the wing tip wing ribs 113.

The wing rotating support rod 111b transfers the reciprocating rotational motion of the third energy storage motor device 230 to the first wing rib 401 via an internal engaged gear, and a differential rotation ratio is determined by the first internal gear 408 and the first external gear 407 of the first wing rib 401, so as to reduce the reciprocating rotational motion angle of the third energy storage motor device 230 and take same as a pitch angle of the first wing rib 401; and the wing rotating support rod 111b transfers the reciprocating rotational motion of the third energy storage motor device 230 to the second wing rib 402, a differential rotation ratio is determined by the second internal gear 412 and the second external gear 411 of the second wing rib 402, so as to reduce the reciprocating rotational motion angle of the third energy storage motor device 230 and take as a pitch angle of the second wing rib 402, wherein the purpose of using an internal engaged gear is to provide a smooth transition in pitch motion from the frame 100 to the entire wing, thereby achieving a basic pitch motion of the entire wing.

In addition, it should be noted that a pitch wing requiring to be manufactured should be able to achieve a smooth and continuous pitch motion, that is to say, in different wing changes, the transmission ratios of some support wing ribs are not consistent, for example, the transmission ratios of the first wing rib 401 and the second wing rib 402 are not consistent, and the first wing rib 401 is closer to the body than the second wing rib 402; therefore, the pitch angle of the first wing rib 401 is less than that of the second wing rib 402 during motion, that is, the transmission ratio of the first wing rib 401 is greater than that of the second wing rib 402, As shown in FIGS. 2, 11 and 12, the center of circle of the first internal gear 408 of the first wing rib 401 is located on the wing fixing support rod 111a, and the center of circle of the second internal gear 412 of the second wing rib 402 is located between the wing rotating support rod 111b and the wing fixing support rod 111a; therefore, the two sets of engagement gears have different design forms. The entire wing structure primarily achieves a support function in the pitch motion, and provides a smooth transition of the wing pitch motion from a baseline of the body to the wing tip.

### (3) Front and Back Swing of the Wing:

Here, the front and back swing of the wing is driven by the second energy storage motor device 220, the second energy storage motor device 220 transfers the front and back swing to the third energy storage motor device 230 via the coupling and the connecting rod 274, and the third energy storage motor device 230 transfers the front and back swing motion to the wing fixing support rod 111a and the wing rotating support rod 111b; the wing fixing support rod 111a and the wing rotating support rod 111b transfer the front and back swing to the first wing rib 401, the second wing rib 402, the third wing rib 403, the fourth wing rib 404 and the fifth wing rib 405 respectively via the wing rib support rods. In addition, the wing rotating support rod 111b transfers the front and back swing to the wing tip support rod 111c via the Rotation device 300, and the wing tip support rod 111c transfers the front and back swing to the sixth wing rib 501, the seventh wing rib 502 and the eighth wing rib 503 via the wing rib support rods.

### (4) Spanwise Bending of the Wing:

Here, the up and down swing of the wing tip is independently driven by the fourth energy storage motor device 240, the reciprocating rotation of the fourth energy storage motor device 240 is transferred to the traction device 400 via the coupling at the output end of the fourth energy storage motor device, and the traction device 400 transfers the reciprocating rotation of the fourth energy storage motor device 240 to the joint portion 320; thus, the reciprocating rotation of the fourth energy storage motor device 240 is converted into an up and down swing motion of the joint portion 320, the joint portion 320 transfers the up and down swing motion to the wing tip support rod 111c, and the wing tip support rod 111c transfers the up and down swing motion to the sixth wing rib 501, the seventh wing rib 502 and the eighth wing rib 503 of the wing tip portion via the wing rib support rods.

The underwater vehicle with a single wing moves on the basis of a combination of the four basic motions, and can exhibit complex hydrofoil motions, which can not only simulate the hydrofoil motion of a living thing, but also greatly improve the propulsive performance of the wing; and superposed motion forms of the underwater vehicle with two wings is more complicated and diversified.

According to the embodiments of the present disclosure, by providing a plurality of energy storage motor devices, the wing of the underwater vehicle can achieve different individual motions, and a combination of a plurality of individual motions can constitute a complex spatial motion, so that the navigation modes of the underwater vehicle are more diversified, and the biomimetic effect is better.

The description above is only illustration about the preferred embodiments of the present disclosure and technical principles adopted. A person skilled in the art should understand that the scope of disclosure involved in the present disclosure is not limited to the technical solutions formed by specifically combining the technical features and should also cover other technical solutions formed by arbitrarily combining the technical features or equivalent features thereof without departing from the inventive concept. For example, technical solutions formed by mutually replacing the features and (but not limited to) the technical features with similar functions disclosed in the present disclosure.

In addition, although various operations are depicted in a specific order, this should not be understood as requiring that these operations be performed in the specific order shown or in sequential order. In certain environments, multi-task and parallel processing may be advantageous. Likewise, while several specific implementation details are comprised in the discussion above, these should not be construed as limiting the scope of the present disclosure. Certain features that are described in the context of individual embodiments can also be implemented in a single embodiment in a combination manner. Conversely, various features that are described in the context of a single embodiment can also be implemented in multiple embodiments individually or in any suitable sub-combination manner.

Although the subject matter has been described in language specific to structural features and/or methodological logic acts, it should be understood that the subject matter defined in the appended claims is not necessarily limited to the specific features or acts described above. Rather, the specific features and acts described above are merely exemplary forms for implementing the claims.

Hereinabove, a plurality of embodiments of the present disclosure have been described in detail, but the present disclosure is not limited to these specific embodiments. On the basis of the concept of the present disclosure, a person skilled in the art could make various variations and modifications, and these variations and modifications shall fall within the scope of protection of the present disclosure.

1. An underwater vehicle, comprising a frame and a driving device, wherein a wing fixing support rod, a wing rotating support rod and a wing tip support rod are provided on the driving device, a first end of the wing fixing support rod and a first end of the wing rotating support rod are movably connected to the driving device, a second end of the wing rotating support rod is movably connected to the wing tip support rod, and at least one main wing rib is provided on the wing fixing support rod and the wing rotating support rod, and at least one wing tip wing rib is sleeved on the wing tip support rod.

2. The underwater vehicle according to claim 1, wherein the driving device comprises a first energy storage motor device, a second energy storage motor device, a third energy storage motor device, a fourth energy storage motor device and a crankshaft, wherein a first end of the crankshaft is fixedly connected to the first energy storage motor device, the middle of the crankshaft is connected to the second energy storage motor device, the second energy storage motor device is connected to the third energy storage motor device via a support portion, and the fourth energy storage motor device is arranged at an output end of the third energy storage motor device, and power output directions of the first energy storage motor device, the second energy storage motor device, the third energy storage motor device and the fourth energy storage motor device are different.

3. The underwater vehicle according to claim 2, wherein the support portion comprises a base, a circular portion and a fixing frame, the base is provided with a fixing column, the circular portion is sleeved on the fixing column, the fixing column is a hollow structure, and the fixing frame is arranged at an output end of the second energy storage motor device, wherein the base comprises a U-shaped portion and an annular portion, the circular portion and the annular portion are arranged in parallel to each other, the U-shaped portion is connected to the output end of the second energy storage motor device, and the circular portion and the annular portion are respectively sleeved on different positions of the third energy storage motor device.

4. The underwater vehicle according to claim 2, wherein any one of the first energy storage motor device, the second energy storage motor device, the third energy storage motor device and the fourth energy storage motor device comprises a motor assembly and a coupling; the motor assembly comprises a motor, an output shaft of the motor is arranged at an output side of the motor assembly, a sliding groove is provided on an end face of the motor assembly, springs are provided in the sliding groove, and one end of the coupling is sleeved on the output shaft and can rotate along with the output shaft, and the other end of the coupling moves in the sliding groove and can compress the springs on the basis of the rotation of the output shaft.

5. The underwater vehicle according to claim 3, wherein a connecting portion is provided at a second end of the crankshaft, and the first energy storage motor device and the connecting portion are respectively connected to the frame.

6. The underwater vehicle according to claim 5, wherein a first connecting assembly and a second connecting assembly are respectively provided on the frame, the first connecting assembly is connected to the first energy storage motor device, and the second connecting assembly is connected to the connecting portion.

7. The underwater vehicle according to claim 3, wherein the third energy storage motor device is fixedly connected to the wing fixing support rod and is movably connected to the wing rotating support rod.

8. The underwater vehicle according to claim 7, wherein the first end of the wing rotating support rod is sleeved on a coupling of the output end of the third energy storage motor device, and the wing fixing support rod and the wing rotating support rod are connected to the support portion via a first fixing assembly.

9. The underwater vehicle according to claim 3, wherein the fourth energy storage motor device is arranged on the wing rotating support rod.

10. The underwater vehicle according to claim 9, wherein one end of the fourth energy storage motor device is fixedly connected to the coupling of the output end of the third energy storage motor device, and the other end of the fourth energy storage motor device is connected to the wing rotating support rod via a second fixing assembly.

11. The underwater vehicle according to claim 10, wherein a rotation control portion is provided on a coupling of an output end of the fourth energy storage motor device, and the rotation control portion is connected to a rotation device via a traction device.

12. The underwater vehicle according to claim 1, wherein a rotation device is provided between the wing rotating support rod and the wing tip support rod.

13. The underwater vehicle according to claim 12, wherein the rotation device comprises a base portion and a joint portion, wherein the base portion is fixedly provided at a second end of the wing rotating support rod, and the base portion comprises two upright columns arranged parallel to each other, a U-shaped support platform is arranged between the upright columns, a rotation shaft is arranged on the support platform, the upright columns are connected to the middle of the rotation shaft, and the joint portion is U-shaped, and two long edges of the joint portion are rotatably connected to the rotation shaft.

14. The underwater vehicle according to claim 12, wherein the driving device and the rotation device are connected via a traction device.

15. The underwater vehicle according to claim 1, wherein at a position close to the frame, a part of the main wing rib is sleeved on the wing fixing support rod and the wing rotating support rod; and at a position away from the frame, a part of the main wing rib is only sleeved on the wing rotating support rod.

16. The underwater vehicle according to claim 15, wherein at a position close to the frame, the wing fixing support rod and the wing rotating support rod are movably connected to the main wing rib in a manner of a wing rib support member and a gear set and/or are movably connected to the main wing rib in a manner of a rotation support, a wing rib support member and a gear set; and at a position away from the frame, the wing rotating support rod is movably connected to the main wing rib in a manner of a wing rib support rod.
